(19) United States
(12) Patent Application Publication
(10) Pub. No.: US 2015/0267022 A1
(43) Pub. Date: Sep. 24, 2015

(54) METHODS OF PRODUCING FOAMS AND NANOCOMPOSITES OF PHTHALONITRILE BASED RESINS, AND FOAMS AND NANOCOMPOSITES PRODUCED THEREOF

(71) Applicants: Xiao Hu, Singapore (SG); Ming Liu, Singapore (SG)

(72) Inventors: Xiao Hu, Singapore (SG); Ming Liu, Singapore (SG)

(21) Appl. No.: 14/673,348

(22) Filed: Mar. 30, 2015

Related U.S. Application Data
(63) Continuation of application No. PCT/SG2013/000424, filed on Sep. 30, 2013.
(60) Provisional application No. 61/707,106, filed on Sep. 28, 2012.

(51) Int. Cl. C08J 9/00; C08J 9/14; B32B 9/00; B32B 15/04; B32B 18/00; B32B 17/06; C08J 9/12; B32B 5/18

(52) U.S. Cl. CPC C08J 9/0066; C08J 9/12; C08J 9/14; B32B 5/18; B32B 15/046; B32B 18/00; B32B 17/066; B32B 9/007; C08J 2377/00; C04B 2237/32; B32B 2250/03; B32B 2266/0214; B32B 2305/022; B32B 2305/026; B32B 2305/30; B32B 2307/304; B32B 2307/102; B32B 2605/00

(57) ABSTRACT

Methods of producing a polymeric foam comprising or consisting of a polymer formed from phthalonitrile monomers having general formula (I), (II), or (III),

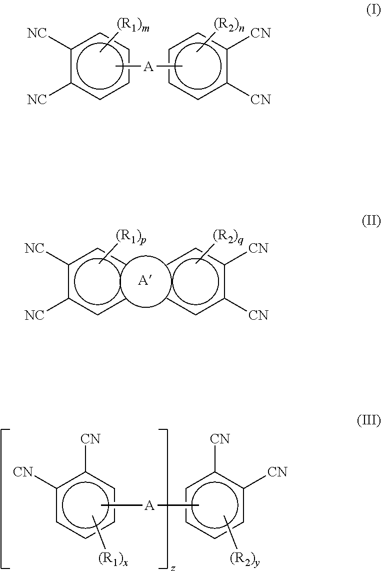

are provided. Polymeric foams and nanocomposites of phthalonitrile based resins, and uses of the polymeric foams are also provided.

### CROSS-REFERENCE TO RELATED APPLICATION

This application claims the benefit of priority of U.S. provisional application No. 61/707,106 filed on 28 Sep. 2012, the content of which is incorporated herein by reference in its entirety for all purposes.

### TECHNICAL FIELD

The invention relates to methods of producing foams and nanocomposites of phthalonitrile based resins, and to foams and nanocomposites produced using the methods.

### BACKGROUND

Polymeric foams have generated great interest as a means to replace traditional metal foams, such as aluminum foams, due to their chemical inertness, superior acoustic properties, strength-to-weight ratio, and ease of fabrication into various forms.

Of the polymeric foams, thermoset based foams are much less developed as compared to thermoplastic foams due to their intractable nature and less versatile processing methods. For example, processing of thermoset based foams often requires synchronization of several parameters, such as processing temperature, rheology profile of the thermoset resin, curing rate, and rate of reaction of the foaming agents.

State of the art methods to produce thermoset based foams include use of physical and/or chemical gas frothing agents/foaming agents (FAs). Good control of the reaction rate is required, as an increase in viscosity that is too slow or too fast may result in incomplete foaming or complete collapse of the voids formed, thereby jeopardizing development of the formed structures. Furthermore, reactions between the polymer resins and curing agents carried out at an inappropriate rate may result in irregularities in the final foam cells. These in turn affect the mechanical properties of the foamed structures. Poor heat tolerance of polymers also render the foamed structures unsuitable for use in many applications.

In view of the above, there remains a need for an improved polymeric foam that addresses at least one of the above-mentioned problems.

### SUMMARY

In a first aspect, the invention refers to a method of producing a polymeric foam comprising or consisting of a polymer formed from phthalonitrile monomers having general formula (I), (II), or (III),

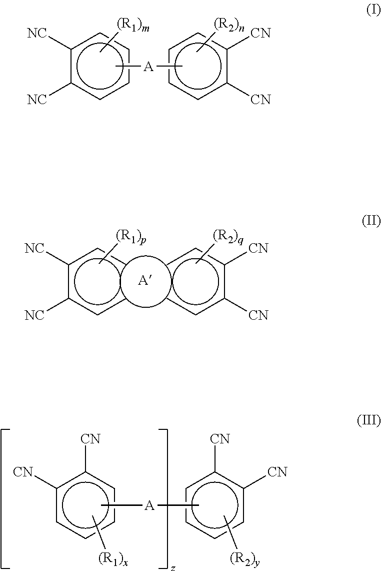

wherein A is a direct bond, or is a linking group selected from the group consisting of optionally substituted C₁-C₂₀ alkyl, optionally substituted C₂-C₂₀ alkenyl, optionally substituted C₂-C₂₀ alkynyl, optionally substituted monocyclic, condensed polycyclic or bridged polycyclic C₅-C₂₀ aryl, optionally substituted C₃-C₂₀ mono-, or poly-cycloalkyl, optionally substituted C₃-C₂₀ mono-, or poly-cycloalkenyl; optionally substituted 2-20-membered heteroalkyl, optionally substituted 2-20-membered heteroalkenyl, optionally substituted 2-20-membered heteroalkynyl, optionally substituted 5-20-membered monocyclic, condensed polycyclic or bridged polycyclic heteroaryl, optionally substituted 3-20-membered mono-, or poly-heterocycloalkyl, and optionally substituted 3-20-membered mono-, or poly-heterocycloalkenyl; —O—, —NR—, and —S—, wherein R is selected from the group consisting of H, optionally substituted C₁-C₆ alkyl and optionally substituted C₅-C₂₀ aryl;
wherein A′ is nothing, or is a linking group selected from the group consisting of optionally substituted monocyclic, condensed polycyclic or bridged polycyclic C₅-C₂₀ aryl and optionally substituted 5-20-membered monocyclic, condensed polycyclic or bridged polycyclic heteroaryl;
wherein each R₁ and each R₂ are independently selected from the group consisting of optionally substituted C₁-C₆ alkyl, optionally substituted C₅-C₂₀ aryl, hydroxy, alkoxy, cyano, halogen group, nitro, silyl, and amino groups;
wherein m, n, x and y is independently 0, 1, 2, or 3; wherein p and q is independently 0, 1 or 2; and wherein z is an integer in the range of 1 to 20;
the method comprising
a) providing monomers having general formula (I), (II), or (III);
b) mixing the monomers with a curing additive at a temperature sufficient to melt the monomers to form a prepolymer;
c) mixing the prepolymer with a foaming agent, and optionally a foaming stabilizer, to form a foaming mixture; and
d) simultaneously foaming and curing the foaming mixture to provide a polymeric foam.

In a second aspect, the invention refers to a polymeric foam produced by a method according to the first aspect.

In a third aspect, the invention refers to a polymeric foam comprising or consisting of a polymer formed from phthalonitrile monomers having general formula (I), (II), or (III),

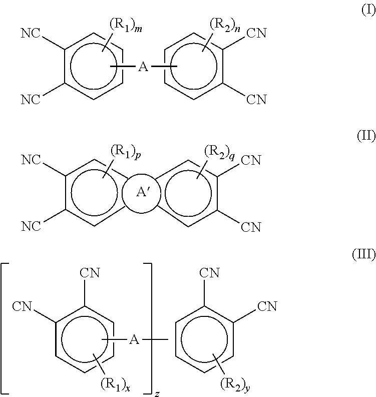

wherein A is a direct bond, or is a linking group selected from the group consisting of optionally substituted C₁-C₂₀ alkyl, optionally substituted C₂-C₂₀ alkenyl, optionally substituted C₂-C₂₀ alkynyl, optionally substituted monocyclic, condensed polycyclic or bridged polycyclic C₅-C₂₀ aryl, optionally substituted C₃-C₂₀ mono-, or poly-cycloalkyl, optionally substituted C₃-C₂₀ mono-, or poly-cycloalkenyl; optionally substituted 2-20-membered heteroalkyl, optionally substituted 2-20-membered heteroalkenyl, optionally substituted 2-20-membered heteroalkynyl, optionally substituted 5-20-membered monocyclic, condensed polycyclic or bridged polycyclic heteroaryl, optionally substituted 3-20-membered mono-, or poly-heterocycloalkyl, and optionally substituted 3-20-membered mono-, or poly-heterocycloalkenyl; —O—, —NR—, and —S—, wherein R is selected from the group consisting of H, optionally substituted C₁-C₆ alkyl and optionally substituted C₅-C₂₀ aryl;
wherein A′ is nothing, or is a linking group selected from the group consisting of optionally substituted monocyclic, condensed polycyclic or bridged polycyclic C₅-C₂₀ aryl and optionally substituted 5-20-membered monocyclic, condensed polycyclic or bridged polycyclic heteroaryl;
wherein each R₁ and each R₂ are independently selected from the group consisting of optionally substituted C₁-C₆ alkyl, optionally substituted C₅-C₂₀ aryl, hydroxy, alkoxy, cyano, halogen group, nitro, silyl, and amino groups;
wherein m, n, x and y is independently 0, 1, 2, or 3; wherein p and q is independently 0, 1 or 2; and wherein z is an integer in the range of 1 to 20.

In a fourth aspect, the invention refers to use of a polymeric foam according to the second aspect or the third aspect for thermal insulation, acoustic insulation, padding purposes, structural materials, flotation devices, automobile, or filtration.

### BRIEF DESCRIPTION OF THE DRAWINGS

The invention will be better understood with reference to the detailed description when considered in conjunction with the non-limiting examples and the accompanying drawings, in which:

FIG. 1 is a schematic diagram of a phthalonitrile (PN) based monomer according to an embodiment. In the embodiment shown, the monomer contains 4 nitrile (C≡N) groups which are attached to one or more aromatic spacer groups collectively represented by Ar.

FIG. 2 is a schematic diagram illustrating foaming mixture preparation and one-step synchronized polymerization-foaming process according to various embodiments.

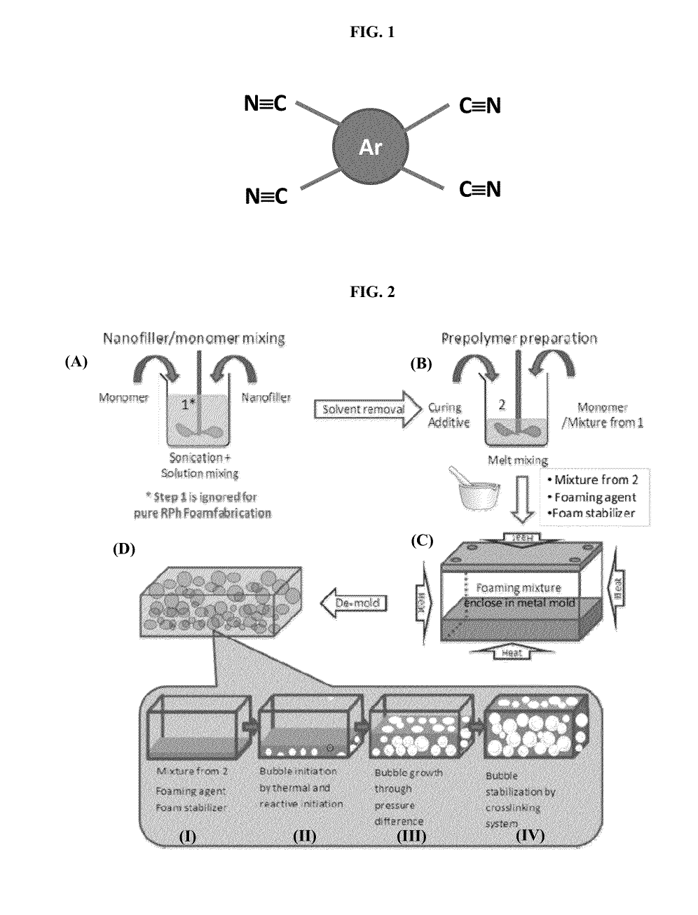

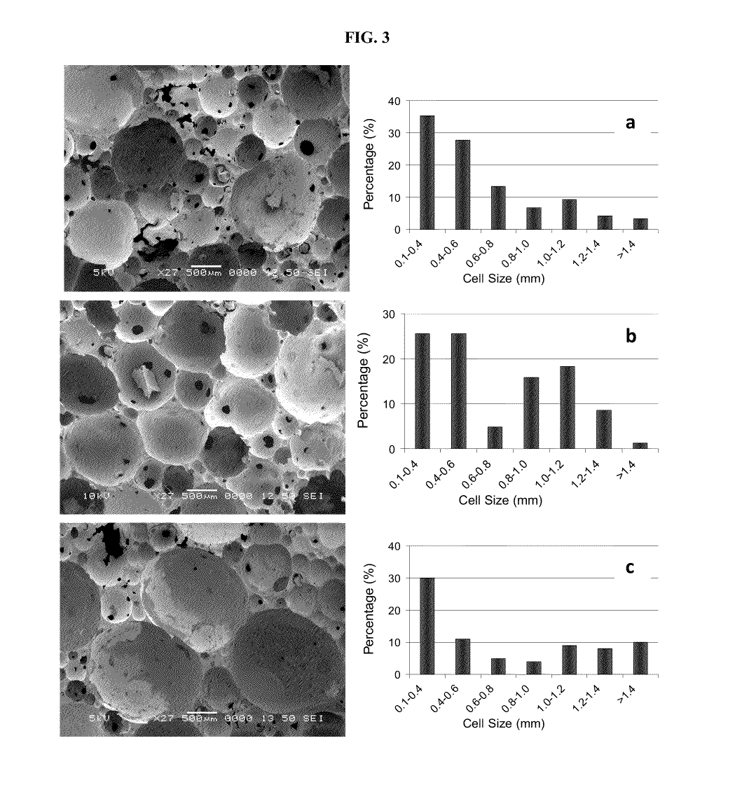

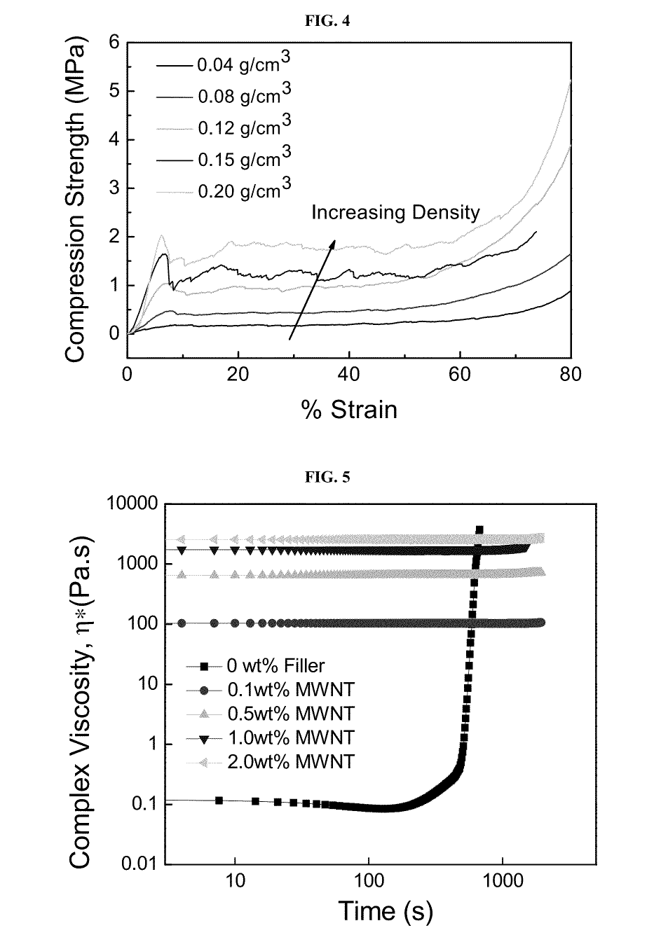

In (A), a nanofiller is mixed with a monomer, which may be carried out under sonication and/or stirring in a solvent. The solvent in (A) is removed prior to addition of a curing additive to form a prepolymer in (B). The process in (B) is carried out at a temperature sufficient to melt the monomers i.e. the monomers are present in a molten form. In (C), a foaming agent and a foaming stabilizer is added to the prepolymer to form a foaming mixture. The foaming mixture is placed in an enclosure, and heat is applied to the foaming mixture, so as to simultaneously foam and cure the foaming mixture to provide a polymeric foam. In so doing, bubble is generated in the foaming mixture while polymerization of the monomers takes place to form the polymeric foam structure. This process is depicted in (I) to (IV), in which (I) shows the initial foaming mixture in the enclosure; (II) shows initiation of bubbles generation by thermal and reactive mechanism; (III) shows bubble growth through pressure difference; and (IV) shows stabilization of the bubbles formed by the cross-linking that takes place in the polymeric matrix as a result of polymerization. Upon demolding, a polymeric foam material is obtained as depicted in (D).

FIG. 3 shows secondary electron imaging (SEI) micrographs of foam cross-section and cell size distribution of (a) 1.5 wt %; (b) 2.5 wt %; and (c) 3.0 wt % foaming agents. All foams shown were foamed under 250° C. In the graphs, y-axis denotes percentage (%) while x-axis denotes cell size (mm) Scale bar in the figures denotes a length of 500 μm.

FIG. 4 is a graph showing stress-strain curves of PN foam showing compression behavior up to densification, for densities of 0.04 g/cm³, 0.08 g/cm³, 0.12 g/cm³, 0.15 g/cm³ and 0.20 g/cm³. Y-axis: compression strength (MPa); x-axis: % strain.

FIG. 5 is a graph showing complex viscosity of PN/MWNT systems of no filler; 0.1 wt % MWNT; 0.5 wt % MWNT; 1.0 wt % MWNT; and 2.0 wt % MWNT as a function of time at constant shear rate of 1/s. Y-axis: complex viscosity η (Pa·s); x-axis: time (s). The graphs clearly demonstrated the extended gelation time and increased complex viscosity due to MWNT additions.

FIG. 6 shows SEI micrographs of foam cross-sections and cell size distributions of (a) neat PN foams with 2.5 wt % of FAs foamed under 250° C.; (b) phthalonitrile/fumed silica (PN/FS); (c) phthalonitrile/multiwalled carbon nanotubes (PN/MWNT); and (d) phthalonitrile/graphite (PN/graphite), all with 2.5 wt % of FAs and foamed at 250° C. In the graphs, y-axis denotes percentage (%) while x-axis denotes cell size (mm) Scale bar in the figures denote a length of 500 μm.

FIG. 7 are digital images showing the PN foams with dimensions of 10 cm×10 cm×2 cm and 20 cm×20 cm×5 cm, demonstrating the potential of scaling up for the foaming method mentioned herein.

FIG. 8 are photographs showing foam according to an embodiment of the invention being subjected to a burn test.

FIG. 9 is a schematic diagram showing a foam structure according to an embodiment of the invention. The figure depicts a sandwich foam structure, in which a polymeric foam (denoted as PN foam core) is sandwiched between two opposing skin layers (denoted as sandwich foam skin). The skin layers may, for example, be arranged in an enclosure before a foaming mixture is placed into the enclosure. In various embodiments, the foaming mixture is simultaneously foamed and cured in the enclosure to form the polymeric foam. Upon demolding from the enclosure, the sandwich foam structure is formed. The skin layers may comprise any material that is able to attach to and/or form a bond with the foam. For example, the skin layers may independently be selected from the group consisting of metal, ceramic, glass fiber mesh, carbon fiber mesh, and mixtures thereof. In embodiments whereby at least a portion of the skin layer is a porous structure, the foaming mixture may infiltrate into the skin layer, thereby strengthening the attachment between the skin layer and the polymeric foam.

### DETAILED DESCRIPTION

Polymers of phthalonitrile based resins are thermally stable. Using a synchronized one-step gas liberation-polymerization process according to embodiments of the invention, polymeric foams formed of a phthalonitrile based resin have been obtained. In so doing, challenges encountered using state of the art thermosetting polymer foaming methods, such as high processing temperature and long curing time, are avoided. Apart from the above, nanocomposites generated by incorporating nanofillers, such as fumed silica and carbon nanotubes, into the polymeric foam during fabrication have also been obtained. These nanofillers are beneficial for microscale reinforcement of the foam structure. By synergistically combining the polymer matrix with nanofillers, improvements in thermal, electrical and mechanical properties may be obtained without altering density of the polymeric foam. Further, by varying the type of nanofillers used, cell morphology of the polymeric foam may be controlled from closed cells to open ‘cage-like’ interconnected cell structures.

Accordingly, in a first aspect, the present invention refers to a method of producing a polymeric foam. As used herein, the term “polymeric foam” refers to a material having one or more foam cells within the material. The term “foam cell” refers to gas bubble that is entrapped in a polymer matrix. Such a gas bubble may be formed during the foaming step by which the polymeric foam is formed. In various embodiments, the foam cell may assume the form of a polymer coated gas bubble.

The polymeric foam comprises or consists of a polymer that is formed from phthalonitrile monomers having general formula (I), (II), or (III)

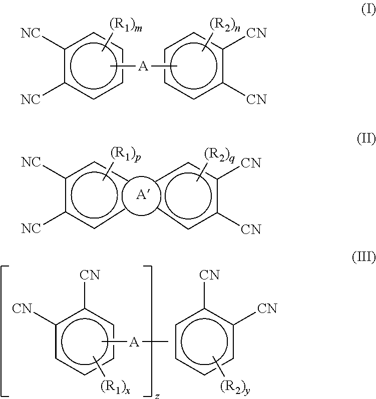

wherein A is a direct bond, or is a linking group selected from the group consisting of optionally substituted C₁-C₂₀ alkyl, optionally substituted C₂-C₂₀ alkenyl, optionally substituted C₂-C₂₀ alkynyl, optionally substituted monocyclic, condensed polycyclic or bridged polycyclic C₅-C₂₀ aryl, optionally substituted C₃-C₂₀ mono-, or poly-cycloalkyl, optionally substituted C₃-C₂₀ mono-, or poly-cycloalkenyl; optionally substituted 2-20-membered heteroalkyl, optionally substituted 2-20-membered heteroalkenyl, optionally substituted 2-20-membered heteroalkynyl, optionally substituted 5-20-membered monocyclic, condensed polycyclic or bridged polycyclic heteroaryl, optionally substituted 3-20-membered mono-, or poly-heterocycloalkyl, and optionally substituted 3-20-membered mono-, or poly-heterocycloalkenyl; —O—, —NR—, and —S—, wherein R is selected from the group consisting of H, optionally substituted C₁-C₆ alkyl and optionally substituted C₅-C₂₀ aryl; wherein A′ is nothing, or is a linking group selected from the group consisting of optionally substituted monocyclic, condensed polycyclic or bridged polycyclic C₅-C₂₀ aryl and optionally substituted 5-20-membered monocyclic, condensed polycyclic or bridged polycyclic heteroaryl; wherein each R₁ and each R₂ are independently selected from the group consisting of optionally substituted C₁-C₆ alkyl, optionally substituted C₅-C₂₀ aryl, hydroxy, alkoxy, cyano, halogen group, nitro, silyl, and amino groups; wherein m, n, x and y is independently 0, 1, 2, or 3; wherein p and q is independently 0, 1 or 2; and wherein z is an integer in the range of 1 to 20.

The term “optionally substituted” refers to a group in which none, one, or more than one of the hydrogen atoms has been replaced with one or more substituent group(s) such as, but not limited to, C₁₋₆ aliphatic group, hydroxy, alkoxy, cyano, halogen group such as F, Cl, Br, I, nitro, silyl, and amino, including mono- and di-substituted amino groups, with the proviso that the substituent group does not contain a functional group that is reactive with the nitrile group on the phthalonitrile monomers. As an example, an optionally substituted alkyl group means that the alkyl group may be substituted or unsubstituted. Exemplary substituents include C₁-C₁₀ alkoxy, C₅-C₁₀ aryl, C₅-C₁₀ aryloxy, sulfhydryl, C₅-C₁₀ arylthio, halogen, hydroxyl, amino, sulfonyl, nitro, cyano, and carboxyl.

The term “optionally substituted C₁-C₂₀ alkyl” refers to a fully saturated aliphatic hydrocarbon. The C₁-C₂₀ alkyl group may be straight chain or branched chain, and may be substituted or unsubstituted. Exemplary substituents have already been mentioned above. Whenever it appears here, a numerical range, such as 1 to 20 or C₁-C₂₀ refers to each integer in the given range, e.g. it means that an alkyl group comprises only 1 carbon atom, 2 carbon atoms, 3 carbon atoms etc. up to and including 20 carbon atoms. Examples of alkyl groups may be, but are not limited to, methyl, ethyl, n-propyl, isopropyl, n-butyl, isobutyl, s-butyl, t-butyl, n-hexyl, n-heptyl, n-octyl, n-nonyl or n-decyl and the like.

The term “optionally substituted C₂-C₂₀ alkenyl” refers to an aliphatic hydrocarbon having one or more carbon-carbon double bonds. The C₂-C₂₀ alkenyl group may be straight chain or branched chain, and may be substituted or unsubstituted. C₂-C₂₀ alkenyl groups include, without limitation, vinyl, allyl, 1-propenyl, 1-butenyl, 2-butenyl, 3-butenyl, 2-methyl-1-propenyl, and 2-methyl-2-propenyl.

The term “optionally substituted C₂-C₂₀ alkynyl” refers to an aliphatic hydrocarbon having one or more carbon-carbon triple bonds. The C₂-C₂₀ alkynyl group may be straight chain or branched chain, and may be substituted or unsubstituted. Examples of alkynyl groups may be, but are not limited to, ethynyl, 1-propynyl, 2-propynyl, 1-butynyl, 2-butynyl, and 3-butynyl, and the like.

The term “optionally substituted C₅-C₂₀ aryl group” refers to a group comprising an aromatic ring, wherein each of the atoms forming the ring is a carbon atom. Aromatic in this context means a group comprising a covalently closed planar ring having a delocalized 7E-electron system comprising 4w+2 π-electrons, wherein w is an integer of at least 1, for example 1, 2, 3 or 4. Aryl rings may be formed by 5, 6, 7, 8, 9, 10, 11, 12, 13, 14, 15, 16, 17, 18, 19 or 20 carbon atoms. In various embodiments, such a group is a C₅-C₁₄ aryl, a C₆-C₁₂ aryl, a C₆ aryl, a C₁₀ aryl, a C₁₂ aryl, or a C₁₄ aryl.

The aryl group may be monocyclic, condensed polycyclic or bridged polycyclic. The term “monocyclic aryl” refers to a monocyclic aromatic carbon ring. Examples of monocyclic aryl groups may be, but are not limited to, phenyl and the like. The term “condensed polycyclic aryl” refers to an aromatic carbon ring structure in which more than 1 monocyclic carbon rings are condensed or fused. Examples include naphthyl, anthracenyl, and phenanthryl. The term “bridged polycyclic aryl” refers to an aromatic carbon ring structure in which 1 aromatic carbon ring is connected to another aromatic carbon ring via a bridging group or atom, such as an alkyl group, O, S, or N, or via a direct bond. Examples include biphenyl, triphenyl, phenyl-naphthyl, binaphthyl, diphenyl ether, diphenyl sulphide, diphenyl disulphide, and the like.

The aryl group is optionally substituted, i.e. the aryl group may be substituted or unsubstituted. As mentioned above, this means that the aryl group has none, one, or more than one hydrogen atom being replaced with one or more substituent group(s), such as, but are not limited to, a C₁₋₆ aliphatic group; a C₃-C₂₀ cycloalkyl or cycloalkenyl group; a C₅-C₁₀ aryl group; a diamide group, an ether group, a sulfone group or a ketone group, with the proviso that the substituent group does not contain a functional group that is reactive with the nitrile group on the phthalonitrile monomers.

The term “aliphatic”, alone or in combination, refers to a straight chain or branched chain hydrocarbon comprising at least one carbon atom. Aliphatics include alkyls, alkenyls, and alkynyls. Aliphatics include, but are not limited to, methyl, ethyl, propyl, isopropyl, butyl, isobutyl, tert.-butyl, pentyl, hexyl, ethenyl, propenyl, butenyl, ethynyl, butynyl, propynyl, and the like, each of which may be optionally substituted.

In the context of various embodiments, by “C₃-C₂₀ cycloalkyl” is meant a group comprising a non-aromatic ring (i.e. an alicyclic ring) wherein each of the atoms forming the ring is a carbon atom. The C₃-C₂₀ cycloalkyl may be formed by three, four, five, six, seven, eight, nine, or more than nine carbon atoms including twenty carbon atoms. The C₃-C₂₀ cycloalkyl may be substituted or unsubstituted. The term “mono-cycloalkyl” refers to a mono-alicyclic ring. Examples of C₃-C₂₀ mono-cycloalkyl may include, but are not limited to, cyclopropane, cyclobutane, cyclopentane, cyclohexane, cycloheptane, and cyclooctane. The term “poly-cycloalkyl” refers to a carbon ring structure in which more than 1 mono-alicyclic carbon rings are fused or bridged. Examples include bicyclobutane, bicyclopentane, tricyclopentane, tricyclohexane, and tetracyclodecane.

By the term “C₃-C₂₀ cycloalkenyl”, in the context of various embodiments, is meant a group comprising a non-aromatic ring (i.e. an alicyclic ring) wherein each of the atoms forming the ring is a carbon atom and contains one or more double bonds. The C₃-C₂₀ cycloalkenyl may be formed by three, four, five, six, seven, eight, nine, or more than nine carbon atoms including twenty carbon atoms. The C₃-C₂₀ cycloalkenyl may be substituted or unsubstituted. The term “mono-cycloalkenyl” refers to a mono-alicyclic ring which contains one or more double bonds. Examples of C₃-C₂₀ mono-cycloalkenyl include cyclopropene, cyclobutene, cyclopentene, cyclohexene, cycloheptene, cyclooctene, 1,3-cyclohexadiene, and 1,4-cyclohexadiene, among others. The term “poly-cycloalkenyl” refers to a carbon ring structure in which more than 1 mono-alicyclic carbon rings are fused or bridged, and the structure has one or more double bonds. Examples of C₃-C₂₀ poly-cycloalkenyl include bicyclobutene, bicyclopentene, tricyclopentene, tricyclohexene, and tetracyclodecene.

The term “heteroalkyl” refers to an alkyl wherein one or more carbon atoms are replaced by a heteroatom. The term “heteroalkenyl” refers to an alkenyl wherein one or more carbon atoms are replaced by a heteroatom. The term “heteroalkynyl” refers to an alkynyl wherein one or more carbon atoms are replaced by a heteroatom.

The term “heteroatom” refers to an atom other than carbon present in a main chain of a hydrocarbon. Heteroatoms are typically independently selected from oxygen, sulfur, nitrogen, and phosphorus.

The terms “1 to 20-membered” or “2 to 20-membered”, refer to the number of straight chain or branched chain atoms including carbon and heteroatoms. In various embodiments, the number of straight chain or branched chain atoms for a 1-20-membered heteroalkyl is from 1-14, from 1-8, from 1-6, from 2-10, from 2-6, from 3-12, from 3-8, or from 4-10. In various embodiments, the number of straight chain or branched chain atoms for a 2-20-membered heteroalkenyl or a 2-20-membered heteroalkynyl is independently from 2-14, from 2-10, from 2-8, from 3-12, from 3-8, or from 4-10.

In the context of various embodiments, the terms “5-20-membered heteroaryl”, has the general above definition of “C₅-C₂₀ aryl”, except in that the heteroaryl is now termed as 5-20-membered, as 1 to 4 of the carbon atoms may be replaced by heteroatoms. Examples of heteroatoms have already been mentioned above. Examples of heteroaryl groups include, but are not limited to, furan, benzofuran, thiophene, benzothiophene, pyrrole, pyridine, indole, oxazole, benzoxazole, isoxazole, benzisoxazole, thiazole, benzothiazole, imidazole, benzimidazole, pyrazole, indazole, tetrazole, quinoline, isoquinoline, pyridazine, purine, pyrazine, furazan, triazole, benzotriazole, pteridine, phenoxazole, oxadiazole, benzopyrazole, quinolizine, cinnoline, phthalazine, quinazoline or quinoxaline, and the like.

The terms “3-20-membered heterocycloalkyl” and “3-20-membered heterocycloalkenyl” have the general above definitions of “C₃-C₂₀ cycloalkyl” and “C₃-C₂₀ cycloalkenyl” respectively, except in the alicyclic ring at least one of the carbon atom in the ring is substituted with a heteroatom. The C₃-C₂₀ heterocycloalkyl or C₃-C₂₀ heterocycloalkenyl may be formed by three, four, five, six, seven, eight, nine, or more than nine atoms including twenty atoms. The C₃-C₂₀ heterocycloalkyls and C₃-C₂₀ heterocycloalkenyls may be substituted or unsubstituted. Examples of C₃-C₂₀ heterocycloalkyls and C₃-C₂₀ heterocycloalkenyls include, but are not limited to, lactams, lactones, cyclic imides, cyclic thioimides, cyclic carbamates, tetrahydrothiopyran, 4H-pyran, tetrahydropyran, piperidine, 1,3-dioxin, 1,3-dioxane, 1,4-dioxin, 1,4-dioxane, piperazine, 1,3-oxathiane, 1,4-oxathiane, tetrahydro-1,4-thiazine, 2H-1,2-oxazine, maleimide, succinimide, barbituric acid, thiobarbituric acid, dioxopiperazine, hydantoin, dihydrouracil, morpholine, trioxane, hexahydro-1,3,5-triazine, tetrahydrothiophene, tetrahydrofuran, pyrroline, pyrrolidine, pyrrolidone, pyrrolidione, pyrazoline, pyrazolidine, imidazoline, imidazolidine, 1,3-dioxole, 1,3-dioxolane, 1,3-dithiole, 1,3-dithiolane, isoxazoline, isoxazohdme, oxazoline, oxazolidine, oxazolidinone, thiazoline, thiazolidine, and 1,3-oxathiolane.

The term “halogen” or “halo” as used herein refers to fluorine, chlorine, bromine or iodine.

Referring to formula (I), A may be a direct bond. For example, the two phenyl dinitrile groups are linked by a bond to form a phthalonitrile monomer. Alternatively, A is a linking group connecting two phenyl dinitrile groups to form a phthalonitrile monomer. For example, the linking group A may be selected from the group consisting of optionally substituted C₁-C₂₀ alkyl, optionally substituted C₂-C₂₀ alkenyl, optionally substituted C₂-C₂₀ alkynyl, optionally substituted monocyclic, condensed polycyclic or bridged polycyclic C₅-C₂₀ aryl, optionally substituted C₃-C₂₀ mono-, or poly-cycloalkyl, optionally substituted C₃-C₂₀ mono-, or poly-cycloalkenyl; optionally substituted 2-20-membered heteroalkyl, optionally substituted 2-20-membered heteroalkenyl, optionally substituted 2-20-membered heteroalkynyl, optionally substituted 5-20-membered monocyclic, condensed polycyclic or bridged polycyclic heteroaryl, optionally substituted 3-20-membered mono-, or poly-heterocycloalkyl, and optionally substituted 3-20-membered mono-, or poly-heterocycloalkenyl; —O—, —NR—, and —S—, wherein R is selected from the group consisting of H, optionally substituted C₁-C₆ alkyl and optionally substituted C₅-C₂₀ aryl.

In various embodiments, linking group A is linked to each phenyl ring of the phenyl dinitrile groups in the meta position with respect to at least one nitrile group. For example, the linking group A may be located on the meta position with respect to the first nitrile group and the para position with respect to the second nitrile group.

Each phenyl dinitrile group in formula (I) is optionally substituted. In various embodiments, each R₁ and each R₂ are independently selected from the group consisting of optionally substituted C₁-C₆ alkyl, optionally substituted C₅-C₂₀ aryl, hydroxy, alkoxy, cyano, halogen group, nitro, silyl, and amino groups. m and n may independently be 0, 1, 2, or 3.

Referring to formula (II), A′ may be nothing, or is a linking group selected from the group consisting of optionally substituted monocyclic, condensed polycyclic or bridged polycyclic C₅-C₂₀ aryl and optionally substituted 5-20-membered monocyclic, condensed polycyclic or bridged polycyclic heteroaryl; wherein each R₁ and each R₂ are independently selected from the group consisting of optionally substituted C₁-C₆ alkyl, optionally substituted C₅-C₂₀ aryl, hydroxy, alkoxy, cyano, halogen group, nitro, silyl, and amino groups; and wherein p and q is independently 0, 1 or 2.

In embodiments where A′ is nothing, the two phenyl dinitrile groups are fused to each other to form a 2,3,6,7-tetranitrile naphthalene compound. In some embodiments, A′ may be an optionally substituted aryl or heteroaryl group that is fused to the two phenyl dinitrile groups. In these embodiments, for example, a phthalonitrile monomer may be represented by two phenyl dinitrile groups connected by a phenyl ring, wherein the phenyl ring is fused to the respective phenyl ring of the phenyl dinitrile groups.

Referring to formula (III), A may be a direct bond, or a linking group selected from the group consisting of optionally substituted C₁-C₂₀ alkyl, optionally substituted C₂-C₂₀ alkenyl, optionally substituted C₂-C₂₀ alkynyl, optionally substituted monocyclic, condensed polycyclic or bridged polycyclic C₅-C₂₀ aryl, optionally substituted C₃-C₂₀ mono-, or poly-cycloalkyl, optionally substituted C₃-C₂₀ mono-, or poly-cycloalkenyl; optionally substituted 2-20-membered heteroalkyl, optionally substituted 2-20-membered heteroalkenyl, optionally substituted 2-20-membered heteroalkynyl, optionally substituted 5-20-membered monocyclic, condensed polycyclic or bridged polycyclic heteroaryl, optionally substituted 3-20-membered mono-, or poly-heterocycloalkyl, and optionally substituted 3-20-membered mono-, or poly-heterocycloalkenyl; —O—, —NR—, and —S—, wherein R is selected from the group consisting of H, optionally substituted C₁-C₆ alkyl and optionally substituted C₅-C₂₀ aryl.

Each phenyl dinitrile group in formula (III) is optionally substituted. In various embodiments, each R₁ and each R₂ are independently selected from the group consisting of optionally substituted C₁-C₆ alkyl, optionally substituted C₅-C₂₀ aryl, hydroxy, alkoxy, cyano, halogen group, nitro, silyl, and amino groups. x and y may independently be 0, 1, 2, or 3. z is an integer in the range of 1 to 20, such as 1, 2, 3, 4, 5, 6, 7, 8, 9, 10, 11, 12, 13, 14, 15, 16, 17, 18, 19, or 20.

It has been found that linking groups formed of aromatic, polar and flexible moieties impart the corresponding phthalonitrile polymers with good thermal and oxidative stability, low water absorptivity, high strength, good dimensional integrity and strong adhesion, whereby it is believed that the aromatic moieties in the linking groups provide high mechanical strength and modulus while the polar moieties in the linking groups provide good adhesive properties.

In some embodiments, A is a linking group selected from the group consisting of imide, bisphenol, dihydroxy benzene, ether, diether, aromatic ether, thioether, phosphine oxide, benzoxaine, and mixtures thereof. In specific embodiments, A comprises or consists of Bisphenol-A, Resorcinol, or mixtures thereof.

The method of the first aspect includes providing monomers having general formula (I), (II), or (III). In various embodiments, providing phthalonitrile monomers having general formula (I), (II), or (III) includes mixing the monomers with a nanofiller. The term “nanofiller” as used herein refers generally to particles having a maximal dimension in the range from about 1 nm to about 100 nm. The nanofiller may be of any shape. For example, the nanofiller may be selected from the group consisting of nanoparticles, nanorods, nanotubes, nanofibers, nanodiscs, nanoplatelets, and mixtures thereof.

As mentioned above, by incorporating a nanofiller to the polymer matrix, improvements in thermal, electrical and mechanical properties of the polymeric foam may be obtained without altering its density. The nanofiller may include a material selected from the group consisting of silica, fumed silica, metal oxide, carbon nanotubes, multiwalled carbon nanotubes, graphite, clay, and mixtures thereof. In various embodiments, the nanofiller comprises or consists essentially of fumed silica, multiwalled carbon nanotubes, or graphite.

The amount of nanofiller in the polymeric foam to be incorporated into the foam depends on the nanofiller type, may be in the range from about 0.1 wt % to about 30 wt %, such as about 0.1 wt % to about 20 wt %, about 0.1 wt % to about 10 wt %, about 0.1 wt % to about 5 wt %, about 0.5 wt % to about 30 wt %, about 0.5 wt % to about 20 wt %, about 0.5 wt % to about 10 wt %, about 0.5 wt % to about 5 wt %, about 0.5 wt % to about 3 wt %, about 0.5 wt % to about 2 wt %, about 0.5 wt % to about 1.5 wt %, about 1 wt % to about 30 wt %, about 1 wt % to about 20 wt %, about 1 wt % to about 10 wt %, about 1 wt % to about 5 wt %, about 2 wt % to about 5 wt %, about 3 wt % to about 5 wt %, about 5 wt % to about 30 wt %, about 5 wt % to about 15 wt %, about 10 wt % to about 30 wt %, about 10 wt % to about 25 wt %, about 20 wt % to about 30 wt %, about 15 wt % to about 25 wt %, about 10 wt % to about 20 wt %, about 5 wt % to about 10 wt %, about 2 wt % to about 4 wt %, or about 1 wt % to about 3 wt %, about 1.5 wt %, about 2.5 wt %, or about 3 wt %. In various embodiments, the amount of nanofiller in the polymeric foam is in the range from about 1.5 wt % to about 3 wt %.

The nanofiller may first be dispersed in a solvent prior to mixing with the phthalonitrile monomers. In various embodiments, the nanofillers are at least substantially uniformly dispersed in the solvent. Agitation, for example, by stirring or sonication may be carried out to facilitate dispersion of the nanofillers in the solvent. Suitable solvents include liquids that do not react with the nanofiller and/or the monomers. Examples of solvent that may be used include, but are not limited to, acetone, ethanol, chlorobenzene, dimethylformamide, tetrahydrofuran, or mixtures thereof. In various embodiments, the solvent comprises or consists of acetone. Upon addition of the nanofiller to the phthalonitrile, agitation by sonication for example, may also be carried out to enhance dispersion of the nanofillers in the monomers.

The method of the first aspect includes mixing the phthalonitrile monomers, which optionally contains a nanofiller, with a curing additive. In embodiments where a nanofiller is added to the monomers, excess solvent from the mixture may be removed prior to mixing of the monomers (and the nanofiller) with the curing additive. Choice of curing additive may depend on, for example, the prepolymer melt viscosity change profile. For example, type and amount of curing additive may affect time required for gelation of the prepolymer melt, whereby the term “gelation” is defined herein as the point during polymerization at which a substantial increase in viscosity is detected. By selecting the type and amount of curing additive based on the prepolymer melt viscosity change profile, the foaming process and the polymerization process may be tailored to result in polymeric foams having different structural features, such as size and density of foam cells in the polymeric foam, for example. In various embodiments, the curing additive comprises or consists of an aromatic amine.

In various embodiments, the curing additive is selected from the group consisting of 1,3-bis(4-aminophenoxy) benzene, 1,4-bis(4-aminophenoxy) benzene, bis[4-(3-aminophenoxyl)phenyl]sulfone, bis[4-(4-aminophenoxyl)phenyl]sulfone, and mixtures thereof.

The amount of curing additive may depend on factors, such as the type of curing additive, the prepolymer melt viscosity change profile, and/or the amount of monomers present. Generally, the amount of curing additive in the prepolymer may be in the range from about 1 mol % to about 7 mol %, such as about 1 mol % to about 5 mol %, about 1 mol % to about 3 mol %, about 3 mol % to about 7 mol %, about 5 mol % to about 7 mol %, about 1 mol %, about 2 mol %, about 3 mol %, about 4 mol %, about 5 mol %, about 6 mol %, or about 7 mol %.

Mixing of the monomers with the curing additive may be carried out at a temperature that is sufficient to melt the monomers. This may in turn depend on the type of monomers that are used. In cases whereby a nanofiller is used, the temperature that is sufficient to melt the monomers may also depend on the type and amount of nanofiller present. In various embodiments, the monomers having general formula (I), (II), or (III) is mixed with the curing additive at a temperature in the range from about 190° C. to about 250° C. For example, the monomers having general formula (I), (II), or (III) may be mixed with the curing additive at a temperature in the range from about 190° C. to about 240° C., about 190° C. to about 220° C., about 190° C. to about 200° C., about 200° C. to about 250° C., about 220° C. to about 250° C., about 230° C. to about 240° C., about 200° C. to about 220° C., or about 215° C. to about 230° C.

By mixing the monomers with the curing additive, a prepolymer is formed. The prepolymer is mixed with a foaming agent, and optionally a foaming stabilizer, to form a foaming mixture. The term “foaming agent” may be used to refer to a substance that, upon heating, decomposes or emits a gas. By heating the foaming mixture containing the prepolymer, the foaming agent and the foaming stabilizer, the foaming agent decomposes or emits a gas upon heating to generate bubbles in the foaming mixture.

Examples of foaming agent that may be used include, but are not limited to, low boiling point organic compounds, metal carbonate, organic compounds which decompose and release gaseous compounds upon heating, or mixtures thereof. Some examples of low boiling point organic compounds include C₁-C₁₂ hydrocarbons, such as ethane, ethene, propane, propene, cyclopropane, butane, butene, butadiene, isobutane, isobutylene, cyclobutane, pentane, pentene, cyclopentane, pentadiene, hexane, cyclohexane, hexene, hexadiene, to name just a few; C₁-C₁₂ organohalogens, C₁-C₁₂ ethers, C₁-C₁₂ esters, C₁-C₁₂ amines, or mixtures thereof. Some examples of organic compounds that decompose include azodinitriles, azo and diazo compounds and their derivatives, nitroso-containing compounds, triazines, or mixture thereof. In various embodiments, the foaming agent comprises or consists of azodicarboxamide and/or its derivatives. Examples of derivatives of azodicarboxamides include, but are not limited to, azodicarboxylate and its salts such as barium azodicarboxylate, strontium azodicarboxylate, and strontium potassium azodicarboxylate.

The amount of foaming agent in the foaming mixture may depend on the type of foaming agent used, the type of phthalonitrile monomers, and the presence/absence of nanofillers. Generally, the amount of foaming agent in the foaming mixture may be in the range from about 1 wt % to about 20 wt %, such as about 1 wt % to about 15 wt %, about 1 wt % to about 10 wt %, about 1 wt % to about 5 wt %, about 5 wt % to about 20 wt %, about 10 wt % to about 20 wt %, about 15 wt % to about 20 wt %, about 5 wt % to about 15 wt %, or about 5 wt % to about 10 wt %. In various embodiments, the amount of foaming agent in the foaming mixture is in the range from about 1 wt % to about 5 wt %.

A foaming stabilizer is optionally added to the prepolymer to form the foaming mixture. The term “foaming stabilizer” as used herein refers to a substance which is added to a mixture or liquid solution so as to prevent rupture of bubbles that are formed in the liquid. The foaming stabilizer may prevent rupture of bubbles in the liquid by affecting the viscosity and surface tension of the liquid solution or mixture. In some embodiments, for example, in embodiments where nanofillers are present in the prepolymer, a foaming stabilizer is not required.

Examples of foaming stabilizers include, but are not limited to, polyoxyalkylene modified dimethylpolysiloxane, polysiloxane oxyalkylene copolymer, silicone glycol copolymers, polyethoxylated phenols, polyethoxylated sorbitan monoesters, sorbitan monoesters, polyoxyethylene sorbitan fatty acid esters, ethylene oxide adducts of caster oil, ethylene oxide adducts of lauryl fatty acid, or mixtures thereof. Besides liquid phased foaming stabilizers, the foaming stabilizer may be a solid. For example, the foaming stabilizers may be solid particles or suspensions of solid particles. Examples of such particles include, but are not limited to, ceramic particles, or polymer-based strands or rod-like particles.

In various embodiments, the foaming stabilizer comprises or consists of a silicone-based compound. Examples of silicone-based compounds include, but are not limited to, dimethylpolysiloxane, polysiloxane oxyalkylene copolymer, and silicone glycol copolymers. In specific embodiments, the foaming stabilizer comprises or consists of hydrophilic silica particles, hydrophilic ceramic particles, or mixtures thereof.

Similar to the case for foaming agents as discussed above, the amount of foaming stabilizer in the foaming mixture may depend on the type of foaming stabilizer and monomers used, as well as whether or not a nanofiller is present in the foaming mixture. Generally, the amount of foaming stabilizer in the foaming mixture may be in the range from about 0 wt % to about 5 wt %. For example, in embodiments where nanofillers are present, a foaming stabilizer may not be required. Accordingly, for such cases, the amount of foaming stabilizer in the foaming mixture is 0 wt %. In embodiments whereby a foaming stabilizer is used, the amount of foaming stabilizer in the foaming mixture may be about 0.1 wt % to about 5 wt %, such as about 0.5 wt % to about 5 wt %, about 1 wt % to about 5 wt %, about 2 wt % to about 5 wt %, about 3 wt % to about 5 wt %, about 4 wt % to about 5 wt %, about 0.1 wt % to about 4 wt %, about 0.1 wt % to about 3 wt %, about 0.1 wt % to about 2 wt %, about 0.1 wt % to about 1 wt %, or about 0.1 wt % to about 0.5 wt %. In various embodiments, the amount of foaming stabilizer in the foaming mixture is in the range from about 0 wt % to about 5 wt %.

The method according to the first aspect includes simultaneously foaming and curing the foaming mixture to provide a polymeric foam. For example, the foaming agent in the foaming mixture may foam and generate bubbles upon application of heat. At the time of bubbles generation in the foaming mixture, polymerization of the monomers also takes place. The heat that is applied to the foaming mixture may activate the curing additive to result in polymerization of the monomers. In some embodiments, the monomers may cross-link via the nitrile groups present on the monomers to form the polymeric foam. The bubbles that are generated in the foaming mixture are stabilized by cross-linking that is induced in the polymer matrix due to polymerization. In various embodiments, the bubbles that are generated are fixed in position or set in the polymeric foam due to polymerization of the monomers. This allows fabrication of low density molded polymeric foam to be fabricated under high temperature. In various embodiments, the polymerization takes place at a faster rate compared to the rate of bubble generation. By carrying out polymerization at a faster rate as compared to the rate of bubble generation, this may provide improved stability for bubbles that are generated in the foaming mixture.

In various embodiments, simultaneously foaming and curing the foaming mixture to provide a polymeric foam includes heating the foaming mixture in an enclosure to a temperature which is the higher of (i) the melting temperature of the monomers, and (ii) the decomposition temperature of the foaming agent. As mentioned above, this allows the foaming agent to decompose to form a gas and/or to emit a gas, thereby forming bubbles in the foaming mixture. Foaming and curing of the foaming mixture takes place concurrently to form the polymeric foam.

In various embodiments, the foaming mixture is heated in a sealed enclosure. By the term “sealed”, this means the enclosure functions as a closed system which is gas tight. In specific embodiments, the foaming mixture is heated in a metal mold.

The temperature at which the foaming mixture is heated is the higher of (i) melting point of the monomers, and (ii) temperature for gas liberation from foaming agent. Generally, the foaming mixture may be heated at a temperature in the range from about 200° C. to about 300° C., such as about 220° C. to about 300° C., about 240° C. to about 300° C., about 260° C. to about 300° C., about 280° C. to about 300° C., about 200° C. to about 280° C., about 200° C. to about 260° C., about 200° C. to about 240° C., about 200° C. to about 220° C., about 220° C. to about 280° C., about 240° C. to about 280° C., about 240° C. to about 260° C., about 240° C., about 250° C., or about 260° C. In specific embodiments, the foaming mixture is heated at a temperature of about 250° C.

The foam cells in the polymeric foam may be of any suitable size and shape. Size of the foam cells in the polymeric foam may be characterized by their maximal dimension. The term “maximal dimension” as used herein refers to the maximal length of a straight line segment passing through the center of a foam cell and terminating at the periphery. In the case of a spherical foam cell for example, the maximal dimension of a foam cell corresponds to its diameter. The term “mean maximal dimension” refers to an average or mean maximal dimension of the foam cells, and may be calculated by dividing the sum of the maximal dimension of each foam cell by the total number of foam cells. Accordingly, size of the foam cells in the polymeric foam may be determined by calculating the maximal dimension of each foam cell, and which may be obtained for foam cells of any shape, for example, foam cells having a regular shape such as a circle, an ellipse, a triangle, a square, a rectangle, a polygon, or an irregular shape.

In various embodiments, the foam cells in the polymeric foam have a size in the range from about 100 μm to about 2000 μm, such as about 500 μm to about 2000 μm, about 1000 μm to about 2000 μm, about 1500 μm to about 2000 μm, about 100 μm to about 1500 m, about 100 μm to about 1000 μm, about 100 μm to about 500 μm, about 500 μm to about 1500 μm, about 500 μm to about 1000 μm, about 1000 μm to about 2000 μm, or about 1500 μm to about 2000 μm. In specific embodiments, the foam cells in the polymeric foam have a size in the range from about 100 μm to about 1500 μm.

In various embodiments, the foam cells in the polymeric foam are present as discrete cells, otherwise termed herein as closed cells. The foam cells in the polymeric foam may be essentially monodisperse. The term “monodisperse” as used herein refers to a polymeric foam having foam cells of the same size, while the term “essentially monodisperse” means that at least 80% by number of the foam cells have a size that is distributed in the range around the most frequent size (the mode or modal size) having a width of ±10% of the most frequent size.

In various embodiments, the foam cells in the polymeric foam are at least substantially interconnected to one another. By interconnecting to one another, the foam cells may assume an open cell structure, in which the foam cells form a network of cells.

According to a second aspect, the invention refers to a polymeric foam produced by a method according to the first aspect. A further aspect of the invention refers to a polymeric foam comprising or consisting of a polymer formed from phthalonitrile monomers having general formula (I), (II), or (III)

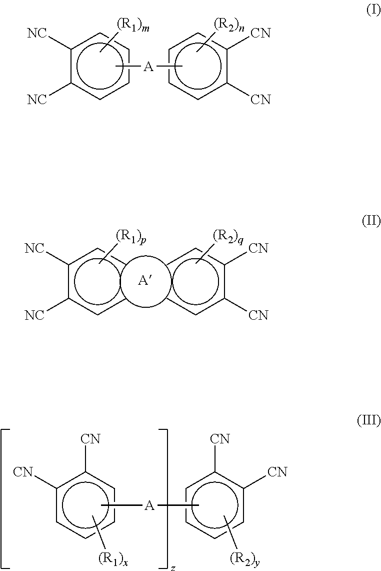

wherein A is a direct bond, or is a linking group selected from the group consisting of optionally substituted C₁-C₂₀ alkyl, optionally substituted C₂-C₂₀ alkenyl, optionally substituted C₂-C₂₀ alkynyl, optionally substituted monocyclic, condensed polycyclic or bridged polycyclic C₅-C₂₀ aryl, optionally substituted C₃-C₂₀ mono-, or poly-cycloalkyl, optionally substituted C₃-C₂₀ mono-, or poly-cycloalkenyl; optionally substituted 2-20-membered heteroalkyl, optionally substituted 2-20-membered heteroalkenyl, optionally substituted 2-20-membered heteroalkynyl, optionally substituted 5-20-membered monocyclic, condensed polycyclic or bridged polycyclic heteroaryl, optionally substituted 3-20-membered mono-, or poly-heterocycloalkyl, and optionally substituted 3-20-membered mono-, or poly-heterocycloalkenyl; —O—, —NR—, and —S—, wherein R is selected from the group consisting of H, optionally substituted C₁-C₆ alkyl and optionally substituted C₅-C₂₀ aryl; wherein A′ is nothing, or is a linking group selected from the group consisting of optionally substituted monocyclic, condensed polycyclic or bridged polycyclic C₅-C₂₀ aryl and optionally substituted 5-20-membered monocyclic, condensed polycyclic or bridged polycyclic heteroaryl; wherein each R₁ and each R₂ are independently selected from the group consisting of optionally substituted C₁-C₆ alkyl, optionally substituted C₅-C₂₀ aryl, hydroxy, alkoxy, cyano, halogen group, nitro, silyl, and amino groups; wherein m, n, x and y is independently 0, 1, 2, or 3; wherein p and q is independently 0, 1 or 2; and wherein z is an integer in the range of 1 to 20. Suitable linking groups A and A′ have already been discussed above.

In various embodiments, the polymeric foam further comprises a nanofiller. For these embodiments, the polymeric foam may also be termed as a nanocomposite. As mentioned above, incorporating nanofillers into the polymeric foam is beneficial for microscale reinforcement of the foam structure. This is because the foam cell wall thickness is within the micron and submicron size regime, therefore, by incorporating the nanofillers into the foam, the cell walls of the foam may be strengthened. Furthermore, by synergistically combining the polymer matrix with nanofillers, improvements in thermal, electrical and mechanical properties may be obtained without altering density of the polymeric foam.

Examples of nanofillers that may be used include, but are not limited to, nanoparticles, nanorods, nanotubes, nanofibers, nanodiscs, nanoplatelets, or mixtures thereof. In some embodiments, the nanofiller comprises a material selected from the group consisting of silica, fumed silica, metal oxide, carbon nanotubes, multiwalled carbon nanotubes, graphite, clay, and mixtures thereof. In specific embodiments, the nanofiller comprises or consists essentially of fumed silica, multiwalled carbon nanotubes, or graphite.

The amount of nanofiller in the polymeric foam may be in the range from about 0.1 wt % to about 30 wt %, such as about 0.1 wt % to about 20 wt %, about 0.1 wt % to about 10 wt %, about 0.1 wt % to about 5 wt %, about 0.5 wt % to about 30 wt %, about 0.5 wt % to about 20 wt %, about 0.5 wt % to about 10 wt %, about 0.5 wt % to about 5 wt %, about 0.5 wt % to about 3 wt %, about 0.5 wt % to about 2 wt %, about 0.5 wt % to about 1.5 wt %, about 1 wt % to about 30 wt %, about 1 wt % to about 20 wt %, about 1 wt % to about 10 wt %, about 1 wt % to about 5 wt %, about 2 wt % to about 5 wt %, about 3 wt % to about 5 wt %, about 5 wt % to about 30 wt %, about 5 wt % to about 15 wt %, about 10 wt % to about 30 wt %, about 10 wt % to about 25 wt %, about 20 wt % to about 30 wt %, about 15 wt % to about 25 wt %, about 10 wt % to about 20 wt %, about 5 wt % to about 10 wt %, about 2 wt % to about 4 wt %, or about 1 wt % to about 3 wt %, about 1.5 wt %, about 2.5 wt %, or about 3 wt %. In various embodiments, the amount of nanofiller in the polymeric foam is in the range from about 1.5 wt % to about 3 wt %.

In various embodiments, the foam cells in the polymeric foam have a size in the range from about 100 μm to about 2000 μm, such as about 500 μm to about 2000 μm, about 1000 μm to about 2000 μm, about 1500 μm to about 2000 μm, about 100 μm to about 1500 μm, about 100 μm to about 1000 μm, about 100 μm to about 500 μm, about 500 μm to about 1500 μm, about 500 μm to about 1000 μm, about 1000 μm to about 2000 μm, or about 1500 μm to about 2000 μm. In specific embodiments, the foam cells in the polymeric foam have a size in the range from about 100 μm to about 1500 μm.

In various embodiments, the foam cells in the polymeric foam are present as discrete cells, otherwise termed herein as closed cells. The foam cells in the polymeric foam may be essentially monodisperse. The term “monodisperse” as used herein refers to a polymeric foam having foam cells of the same size, while the term “essentially monodisperse” means that at least 80% by number of the foam cells have a size that is distributed in the range around the most frequent size (the mode or modal size) having a width of ±10% of the most frequent size.

In various embodiments, the foam cells in the polymeric foam are at least substantially interconnected to one another. By interconnecting to one another, the foam cells may assume an open cell structure, in which the foam cells form a network of cells.

As mentioned above, cell morphology of the polymeric foam may be varied by varying the type of nanofillers used. In particular, it has been found by the inventors of the present application that by varying the type of nanofillers used, cell morphology of the polymeric foam may be controlled from closed cells (discrete cells) to open ‘cage-like’ structure (interconnected cells).

In various embodiments, the polymeric foam is sandwiched between a first skin layer and a second skin layer, the first skin layer and second skin layer being arranged on opposing sides of the polymeric foam.

To serve as an illustration, FIG. 9 is a schematic diagram depicting a foam structure according to an embodiment. The figure shows a sandwich foam structure, in which a polymeric foam is sandwiched between two opposing skin layers. The sandwich foam structure may be formed by arranging a first skin layer and a second skin layer on opposing sides of an enclosure before a foaming mixture is placed into the enclosure. After the foaming mixture is simultaneously foamed and cured in the enclosure to form the polymeric foam, the polymeric foam is demolded from the enclosure to form the sandwich foam structure.

The skin layers may comprise any material that is able to attach to and/or form a bond with the foam. For example, the skin layers may independently be selected from the group consisting of metal, ceramic, glass fiber mesh, carbon fiber mesh, and mixtures thereof. In various embodiments, the first skin layer and/or second skin layer is a metal plate, a ceramic plate, a glass fiber mesh, or a carbon fiber mesh. In various embodiments, the first skin layer and the second skin layer are carbon fiber meshes and/or aluminum plates.

In various embodiments, at least a portion of the first skin layer and/or the second skin layer that is in contact with the polymeric foam is porous. Such embodiments may be advantageous in that the foaming mixture may infiltrate into the skin layer, thereby strengthening the attachment between the skin layer and the polymeric foam.

In a fourth aspect, the invention refers to use of a polymeric foam according to the second aspect or the third aspect for thermal insulation, acoustic insulation, padding purposes, structural materials, flotation devices, automobile, or filtration.

Advantageously, a polymeric foam according to various embodiments is suitable for use at high temperature applications at temperatures up to 300° C. for an extended period of time without substantial deterioration in mechanical properties. The polymeric foam may also be used for bio-related, filtration applications where structural porosity is highly desirable.

As used herein, the term “and/or” includes any and all combinations of one or more of the associated listed items. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXPERIMENTAL SECTION

### Example 1

### Preparation of Prepolymer

Prepolymer was prepared by adding aromatic amine curing additive (1-7 mol %) to the molten phthalonitrile (PN) monomer in three-neck reaction flask under nitrogen protection prior to quenching. As viscosity of the prepolymer melt may determine the foaming grade, morphology and properties, viscosity of the prepolymer melt viscosity was carefully controlled by adjusting the amine curing additive contents.

### Example 2

### PN/Fumed Silica (FS) Nanocomposite Mixture Preparation

0.2 g of FS was first solution sonicated in 5 ml of acetone to obtain uniformly dispersed FS suspension before added to 10 g of monomer in 20 ml of acetone. The mixture was sonicated for 2 hours to enhance FS dispersion. Excess solvent was removed at the end of sonication and the solid mixture was dried in vacuum oven overnight. The well mixed mixture was melt blended for 2 hours in nitrogen before adding in the curing additive for prepolymer preparation.

### Example 3

### PN/Multiwalied Carbon Nanotubes (MWNT) Nanocomposite Mixture Preparation

The preparation method was similar to Example 2, except 0.05 g of MWNT was first sonicated by high power probe sonicator for 15 minutes in 5 ml of acetone before solution and melt mixing.

### Example 4

### PN/Graphite (GH) Nanocomposite Mixture Preparation

The preparation method was similar to Example 2, except 0.05 g of GH was first sonicated by high power probe sonicator for 15 minutes in 5 ml of acetone before solution and melt mixing.

### Example 5

### General Procedure for Preparing PN and its Nanocomposite Foams

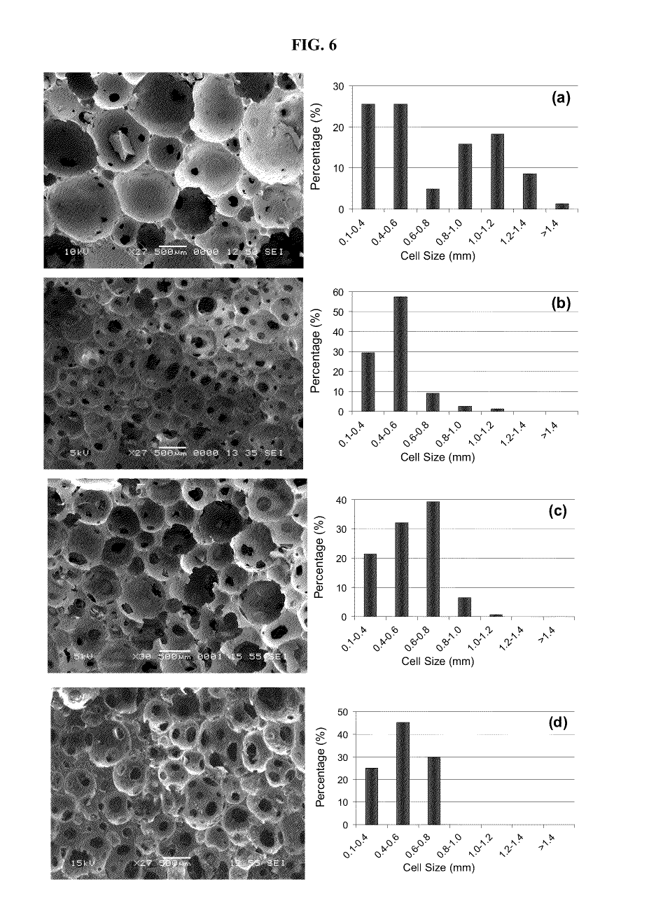

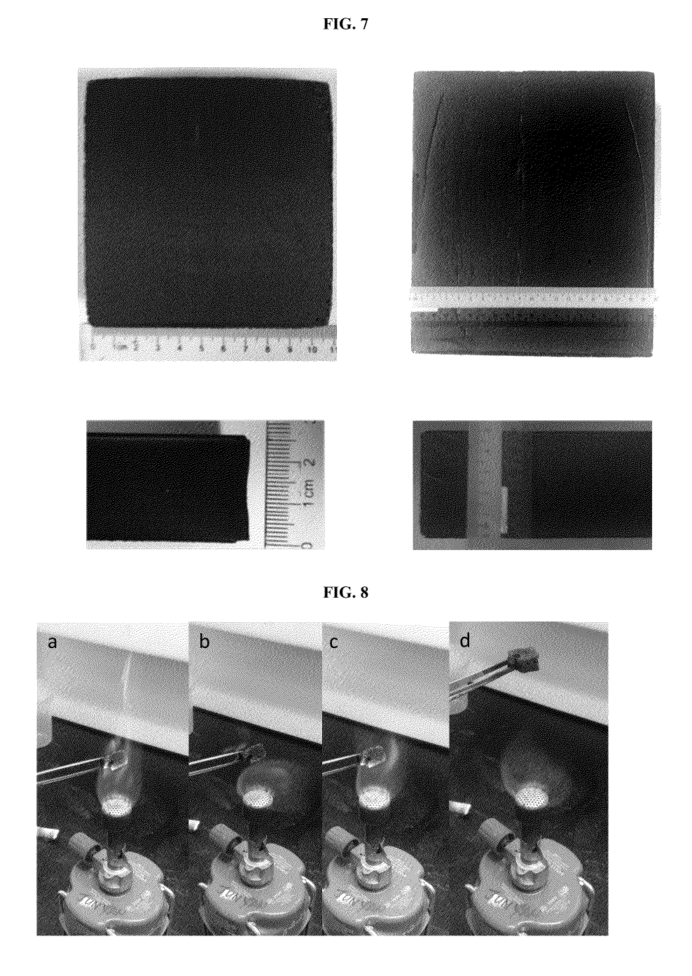

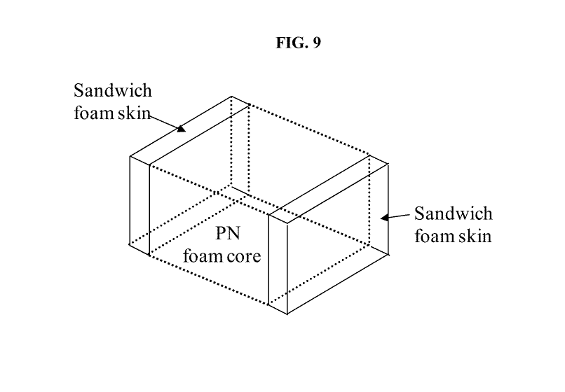

FIG. 2 depicts a general scheme for fabricating PN and its nanocomposite foams. PN foaming mixture formulation contains: PN prepolymer (preparation illustrated in Example 1), FAs, foaming stabilizer and mold release were premixed and placed in a closed aluminium mold system. FAs (metal carbonates, low boiling point organic compounds, azo-compounds) were pre-calculated (1-20 wt %) to obtain the desired density.

FAs used in various embodiments include metal carbonates, high boiling point organic compounds, and azo based compounds with high thermal degradation temperatures. Foaming stabilizers used in this invention include silicone based compounds.

The mold was subjected to temperature above both the melting point of PN and the temperature for gas liberation from FAs. Gases released from FA upon thermal and reactive reactions initiated cell formations and later grew due to pressure difference. The gaseous cells defined by the gases liberated from FAs were stabilized by the crosslinking polymer or physical gel formed for PN foams and PN nanocomposite foams respectively.

Table 1 shows the compression properties of foams as a function of density for foams formed under the same conditions, peak stress, stress at 50% stain were included.

| Density | Peak Stress | Stress at 50% |
|---|---|---|
| (g/cm³) | σ_{y} (MPa) | strain (MPa) |
| 0.04 | — | 0.22 ± 0.08 |
| 0.08 | 0.45 ± 0.04 | 0.49 ± 0.04 |
| 0.12 | 1.04 ± 0.03 | 0.89 ± 0.06 |
| 0.15 | 1.60 ± 0.03 | 1.27 ± 0.02 |
| 0.20 | 2.00 ± 0.04 | 1.78 ± 0.02 |

Table 2 shows the thermal oxidative parameters of foams obtained by thermogravimetric analysis (TGA). All samples were tested after subjected to 6 stages of postcuring.

| | | | |
|---|---|---|---|
| | Onset | Char | Char |
| | Degradation | yield at | yield at |
| | ° C. | 600° C. | 800° C. |
| Density | (5 wt % loss) | (wt %) | (wt %) |

| (g/cm³) | N₂ | Air | N₂ | Air | N₂ | Air |
|---|---|---|---|---|---|---|
| 0.08 | 496 | 483 | 78.7 | 72.3 | 63.5 | 13.5 |
| 0.12 | 478 | 465 | 77.2 | 70.5 | 63.8 | 13.6 |
| 0.15 | 490 | 481 | 79.6 | 73.6 | 66.2 | 14.6 |
| 0.20 | 511 | 500 | 82.3 | 77.7 | 68.5 | 17.8 |

Table 3 shows the foam weight loss and compression strength retention after 100 hours of thermal aging at 300° C. in air.

| | | |
|---|---|---|
| Aging time | Weight loss | Compression strength σ(MPa) |

| (hours) | (wt %) | σₚₑₐₖ | σ_{50%} |
|---|---|---|---|
| 0 | 0 | 1.35 | 1.10 |
| 50 | 7.2 | — | — |
| 100 | 18.1 | 1.20 | 1.05 |
| % retention | — | 88.9 | 95.5 |

### Example 6

### Nanocomposite Foam Density and Mechanical Properties

Table 4 summarizes the foam density and specific compression strength at different nanofillers loading. When added at the right quantity, nanofiller additions effectively narrowed down the cell size distribution. Although it was suggested that the addition of nanofillers sometimes increase the foam density, the claimed material and foaming method maintained the foam densities as long as the foaming process allows foaming to occur. Fillers such as treated carbon nanotubes and graphite increased the compression properties.

Table 4 shows foam density and specific compression strength at different nanofillers loadings.

| | Fumed silica | | MWNT | | GH | |
|---|---|---|---|---|---|---|
| | | Specific | | Specific | | Specific |
| Nanofiller | Density | Compression | Density | Compression | Density | Compression |
| (wt %) | (g/cm³) | Strength (MPa) | (g/cm³) | Strength (MPa) | (g/cm³) | Strength (MPa) |
| 0 | 0.15 ± 0.01 | 7.21 | 0.15 ± 0.01 | 7.21 | 0.15 ± 0.01 | 7.21 |
| 0.1 | 0.15 ± 0.01 | —*¹ | 0.15 ± 0.01 | 7.45 | 0.15 ± 0.01 | 7.85 |
| 0.5 | 0.15 ± 0.01 | —*¹ | 0.15 ± 0.01 | 7.89 | 0.15 ± 0.01 | 8.57 |
| 1 | 0.15 ± 0.01 | 7.14 | 0.15 ± 0.01 | 9.59 | 0.15 ± 0.01 | 10.92 |
| 2 | 0.15 ± 0.01 | 7.35 | 0.15 ± 0.01 | 8.39 | 0.15 ± 0.01 | 7.73 |
| 3 | 0.15 ± 0.01 | 6.80 | 0.15 ± 0.01 | —*² | 0.15 ± 0.01 | —*² |
| 4 | 0.15 ± 0.01 | 5.30 | 0.15 ± 0.01 | —*² | 0.15 ± 0.01 | —*² |

*¹no data available,
*²Foaming was unsuccessful at excessive filler loadings.

Table 5 shows foam density, cell density and average cell diameter of pure and nanocomposite RPh foams.

| | Foam Density | Cell Density | Average cell |
|---|---|---|---|
| Foam Type | g/cm³ | (Nₒ) × 10⁸/cm³ | Diameter (μm) |
| Pure RPh | 0.15 ± 0.01 | 0.0035 | 750 |
| 2 wt %-FS/RPh | 0.15 ± 0.01 | 9.3 | 510 |
| 1 wt %-MWNT/RPh | 0.15 ± 0.01 | 8.1 | 570 |
| 1 wt %-GH/RPh | 0.15 ± 0.01 | 5.4 | 640 |

### Example 7

### Flammability

Bottled gas burner was used for burn test of the foamed samples. The foams took a while to ignite into red flame (FIG. 8a) which extinguish immediately when removed from the fire (FIG. 8b). Continue exposure to direct fire removed the volatiles in the foams and the no flame was observed upon further burning (FIG. 8c).

Samples charred and remained rigid after the burnt for 5 minutes continuously (FIG. 8d). No melting or softening of samples was observed. The shape and mechanical integrity were retained.

### Example 8

### Moisture Absorption

The as foamed samples were dried in vacuum oven for 1 week before subject to 100% humidity at 60° C., weight changes were recorded till weight changed became constant.

Table 6 shows moisture absorption expressed as weight gain.

| | Exposure to moisture (Day) | | | | | | | | |
|---|---|---|---|---|---|---|---|---|---|
| | 1 | 2 | 3 | 4 | 5 | 6 | 7 | 10 | 15 |
| Weight | 2.36 | 2.81 | 3.30 | 3.51 | 3.51 | 3.51 | 3.51 | 3.51 | 3.51 |
| gain | | | | | | | | | |
| (%) | | | | | | | | | |

Various embodiments of the invention describe a one-step foaming method to fabricate PN based thermoset, the only PN based foam ever fabricated. Till date, porous structures made from any PN based polymers have not been formed. Through viscosity tuning and foaming agent selection, PN foams with precisely controlled density have been developed.

There are limited reports on high temperature (HT) polymer foams which may be used under high temperature (>300° C.). Thermal and mechanical performance of the polymer foams under high temperature and long term aging are major issues. PN and nanocomposite foams described herein have exhibited the highest thermal stability among the known thermoset foams and have greatly widened the potential applications of the polymer.

Nanofillers greatly interfered with the PN crosslinking process; the gelation time for the foaming system with nanofiller was increased by a considerable amount as shown in FIG. 5 and caused the synchronized gas liberation-polymerization foaming method to be invalid. The disclosure describes the fabrication of PN nanocomposite foams through the formation of physical gel when crosslinking process failed to occur within the gas liberation time.

As described herein, simple one step foaming pathway was used, making the development easy and controllable. The cell morphology could be controlled through from closed cell structure to open ‘cage-like’ while preserving the desired foam density through nanofiller selections. By using a method described in this application, PN foams in various 3D shapes may be formed.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of producing a polymeric foam comprising or consisting of a polymer formed from phthalonitrile monomers having general formula (I), (II) or (III), 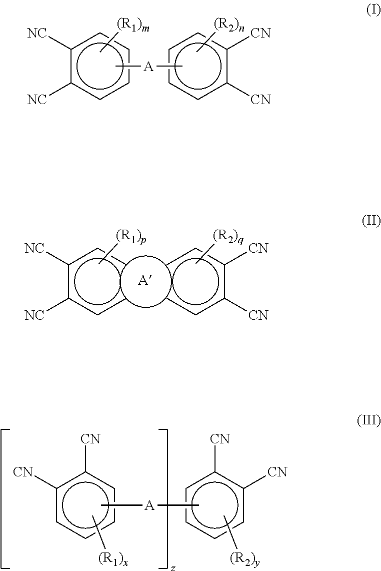
wherein A is a direct bond, or is a linking group selected from the group consisting of optionally substituted C₁-C₂₀ alkyl, optionally substituted C₂-C₂₀ alkenyl, optionally substituted C₂-C₂₀ alkynyl, optionally substituted monocyclic, condensed polycyclic or bridged polycyclic C₅-C₂₀ aryl, optionally substituted C₃-C₂₀ mono-, or poly-cycloalkyl, optionally substituted C₃-C₂₀ mono-, or poly-cycloalkenyl; optionally substituted 2-20-membered heteroalkyl, optionally substituted 2-20-membered heteroalkenyl, optionally substituted 2-20-membered heteroalkynyl, optionally substituted 5-20-membered monocyclic, condensed polycyclic or bridged polycyclic heteroaryl, optionally substituted 3-20-membered mono-, or poly-heterocycloalkyl, and optionally substituted 3-20-membered mono-, or poly-heterocycloalkenyl; —O—, —NR—, and —S—, wherein R is selected from the group consisting of H, optionally substituted C₁-C₆ alkyl and optionally substituted C₅-C₂₀ aryl;
wherein A′ is nothing, or is a linking group selected from the group consisting of optionally substituted monocyclic, condensed polycyclic or bridged polycyclic C₅-C₂₀ aryl and optionally substituted 5-20-membered monocyclic, condensed polycyclic or bridged polycyclic heteroaryl;
wherein each R₁ and each R₂ are independently selected from the group consisting of optionally substituted C₁-C₆ alkyl, optionally substituted C₅-C₂₀ aryl, hydroxy, alkoxy, cyano, halogen group, nitro, silyl, and amino groups;
wherein m, n, x and y is independently 0, 1, 2, or 3; wherein p and q is independently 0, 1 or 2; and wherein z is an integer in the range of 1 to 20;
the method comprising
a) providing phthalonitrile monomers having general formula (I), (II), or (III);
b) mixing the monomers with a curing additive at a temperature sufficient to melt the monomers to form a prepolymer;
c) mixing the prepolymer with a foaming agent, and optionally a foaming stabilizer, to form a foaming mixture; and
d) simultaneously foaming and curing the foaming mixture to provide a polymeric foam.

2. The method of claim 1, wherein step d) includes heating the foaming mixture in an enclosure to a temperature which is the higher of (i) the melting temperature of the monomers, and (ii) the decomposition temperature of the foaming agent.

3. The method according to claim 1, wherein A is selected from the group consisting of Bisphenol-A, Resorcinol, and mixtures thereof.

4. The method according to claim 1, wherein providing phthalonitrile monomers having general formula (I), (II), or (III) comprises mixing the monomers with a nanofiller.

5. (canceled)

6. The method according to claim 4, wherein the nanofiller comprises a material selected from the group consisting of silica, fumed silica, metal oxide, carbon nanotubes, multiwalled carbon nanotubes, graphite, clay, and mixtures thereof.

7.-10. (canceled)

11. The method according to a claim 1, wherein
the curing additive comprises or consists of an aromatic amine selected from the group consisting of 1,3-bis(4-aminophenoxy) benzene, 1,4-bis(4-aminophenoxy) benzene, bis[4-(3-aminophenoxyl)phenyl]sulfone, bis[4-(4-aminophenoxyl)phenyl]sulfone, and mixtures thereof.

12. The method according to claim 1, wherein the amount of curing additive in the prepolymer is in the range from about 1 mol % to about 7 mol %.

13. The method according to claim 1, wherein the monomers having general formula (I), (II), or (III) is mixed with the curing additive at a temperature in the range from about 190° C. to about 250° C.

14. The method according to claim 1, wherein the foaming agent is selected from the group consisting of a metal carbonate, a low boiling point organic compound, an azo-compound or its derivatives, and mixtures thereof.

15. (canceled)

16. The method according to claim 1, wherein the amount of foaming agent in the foaming mixture is in the range from about 1 wt % to about 20 wt %.

17. (canceled)

18. The method according to claim 1, wherein the foaming stabilizer comprises or consists of a silicone-based compound.

19. The method according to claim 1, wherein the foaming stabilizer comprises or consists of hydrophilic silica particles, hydrophilic ceramic particles, or mixtures thereof.

20. The method according to claim 1, wherein the foaming mixture is heated at a temperature in the range from about 200° C. to about 300° C.

21.-25. (canceled)

26. The method according to claim 1, wherein the foam cells in the polymeric foam are at least substantially interconnected, and wherein the foam cells have a size in the range from about 100 μm to about 1500 μm.

27. (canceled)

28. A polymeric foam comprising or consisting of a polymer formed from phthalonitrile monomers having general formula (I), (II) or (III), 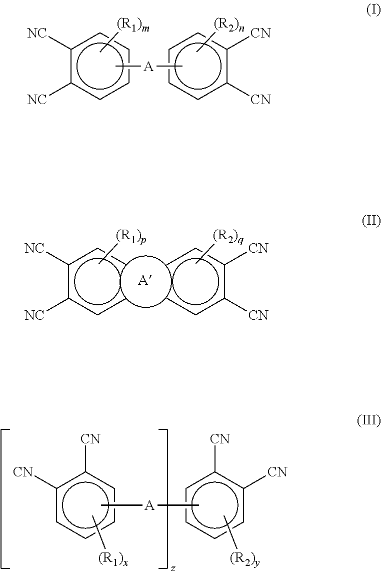
wherein A is a direct bond, or is a linking group selected from the group consisting of optionally substituted C₁-C₂₀ alkyl, optionally substituted C₂-C₂₀ alkenyl, optionally substituted C₂-C₂₀ alkynyl, optionally substituted monocyclic, condensed polycyclic or bridged polycyclic C₅-C₂₀ aryl, optionally substituted C₃-C₂₀ mono-, or poly-cycloalkyl, optionally substituted C₃-C₂₀ mono-, or poly-cycloalkenyl; optionally substituted 2-20-membered heteroalkyl, optionally substituted 2-20-membered heteroalkenyl, optionally substituted 2-20-membered heteroalkynyl, optionally substituted 5-20-membered monocyclic, condensed polycyclic or bridged polycyclic heteroaryl, optionally substituted 3-20-membered mono-, or poly-heterocycloalkyl, and optionally substituted 3-20-membered mono-, or poly-heterocycloalkenyl; —O—, —NR—, and —S—, wherein R is selected from the group consisting of H, optionally substituted C₁-C₆ alkyl and optionally substituted C₅-C₂₀ aryl;
wherein A′ is nothing, or is a linking group selected from the group consisting of optionally substituted monocyclic, condensed polycyclic or bridged polycyclic C₅-C₂₀ aryl and optionally substituted 5-20-membered monocyclic, condensed polycyclic or bridged polycyclic heteroaryl;
wherein each R₁ and each R₂ are independently selected from the group consisting of optionally substituted C₁-C₆ alkyl, optionally substituted C₅-C₂₀ aryl, hydroxy, alkoxy, cyano, halogen group, nitro, silyl, and amino groups;
wherein m, n, x and y is independently 0, 1, 2, or 3; wherein p and q is independently 0, 1 or 2; and wherein z is an integer in the range of 1 to 20.

29. (canceled)

30. The polymeric foam according claim 28, wherein A is selected from the group consisting of Bisphenol-A, Resorcinol, and mixtures thereof.

31. The polymeric foam according to claim 28, wherein the polymeric foam further comprises a nanofiller.

32. (canceled)

33. The polymeric foam according to claim 31, wherein the nanofiller comprises a material selected from the group consisting of silica, fumed silica, metal oxide, carbon nanotubes, multiwalled carbon nanotubes, graphite, clay, and mixtures thereof.

34.-39. (canceled)

40. The polymeric foam according to claim 28, wherein the polymeric foam is sandwiched between a first skin layer and a second skin layer, the first skin layer and second skin layer being arranged on opposing sides of the polymeric foam, wherein the first skin layer and the second skin layer are independently selected from the group consisting of metal, ceramic, glass fiber mesh, carbon fiber mesh, and mixtures thereof.

41. (canceled)

42. The polymeric foam according to claim 40 or 41, wherein at least a portion of the first skin layer and/or the second skin layer that is in contact with the polymeric foam is porous.

43. (canceled)
